(19) United States
(12) Patent Application Publication
(10) Pub. No.: US 2022/0126428 A1
(43) Pub. Date: Apr. 28, 2022

(54) Manual Device for Installing and Removing Knife Blades Into and From Knife Holders of Slitting Machines

(71) Applicant: Dienes Corporation USA, Spencer, MA (US)

(72) Inventors: Daniel Cadrin, Sutton, MA (US); Wade Gilman, Templeton, MA (US)

(21) Appl. No.: 17/081,413

(22) Filed: Oct. 27, 2020

(51) Int. Cl. B25B 27/14; B26D 7/26

(52) U.S. Cl. CPC B25B 27/14; B26D 7/2621

(57) ABSTRACT

A device for installing and removing knife blades from knife holders of slitting machines. Pivotably interconnected grip handles have extensions, each of which has two spaced apart gripping arms. The extensions are also pivotably disposed relative to one another so that they can be separated from one another and drawn toward one another by movement of the grip handles away from and toward one another, whereby the gripping arms can also move toward one another onto hubs of a knife blade, with one of the gripping arms of each extension being disposed on each side of the knife blade and on opposite sides of the hubs.

### BACKGROUND OF THE INVENTION

The present invention relates to a manual device for installing and removing essentially circular knife blades into and from knife holders of slitting machines.

Applicant's manual device is used in conjunction with slitting machines that are used to cut a large variety of sheets of material, by way of example only, sheets of paper, fabric, plastic film, metal, fiberglass, etc.

In the past, the installation and removal of knife blades into and from knife holders of such slitting machines has been accomplished in a very unacceptable manner by gripping an edge of a knife blade with pliers, which can not only easily result in damage to the knife blade, but also poses a risk of injury to an operator if the knife blade is not gripped tightly enough and the operator's hand slips down onto the sharp edge of the knife blade.

There is thus a need for a safe and more reliable way to install a knife blade into, and remove a knife blade from, a knife holder of a slitting machine.

It is therefore an object of the present application to provide a safe and reliable device for accomplishing this.

### BRIEF DESCRIPTION OF THE DRAWINGS

This object, and other objects and advantages of the present invention, will appear more clearly from the following specification in conjunction with the accompanying schematic drawings, in which:

FIG. 1 is a view of applicant's manual device in position on the hubs of a knife blade that is being held in a knife holder of a slitting machine;

FIG. 1a is an enlarged view of the encircled portion A of FIG. 1;

FIG. 2: shows the manual device of FIG. 1 grasping one of the hubs of a knife blade on one side; and

FIG. 3: in an inverted position, shows the manual device of FIG. 1 grasping the other hub of the knife blade on the opposite side.

### SUMMARY OF THE INVENTION

In particular, applicant has invented a manual device, for installing and removing essentially circular knife blades into and from knife holders of slitting machines, that comprises a first and a second grip handle that are pivotably interconnected by means of a pivot pin; a first extension of the first grip handle, wherein such first extension extends away from the first grip handle on a side of the pivot pin that is opposite from the first grip handle, wherein the first extension is provided with two first gripping arm portions that are disposed on an end of the first extension that is remote from the pivot pin, and wherein the first two gripping arm portions are spaced apart from one another, and a second extension of the second grip handle, wherein such second extension extends away from the second grip handle on a side of the pivot pin that is remote from the second grip handle, wherein the second extension is provided with two second gripping arm portions that are disposed on an end of the second extension that is remote from the pivot pin, wherein the two second gripping arm portions are spaced from one another, further wherein the first and second extensions are pivotably disposed relative to one another by means of the pivot pin such that the extensions are adapted to be separated from one another and drawn toward one another by movement of the grip handles away from and toward one another respectively, and wherein movement of the grip handles toward one another results in movement of the two first extension gripping arm portions and of the two second extension gripping arm portions toward one another onto hubs of a knife blade such that one of the first gripping arm portions and one of the second gripping arm portions are disposed on one planar side of the knife blade while the other of the first and second gripping arm portions are disposed on an axially opposite side of the knife blade, and the first gripping arms and the second gripping arms on each respective planar side of the knife blade are on opposite axial sides of the hubs of the knife blade.

With applicant's novel device, rather than having to rely on a frictional grip via pliers onto an edge of the knife blade, there are now four points of engagement, namely two on each side of the knife blade by grasping opposite sides of each of the two hubs of the knife blade by means of the two gripping arm portions that are disposed on each side of the knife blade.

Pursuant to one specific embodiment of the present invention, ends of the first and second gripping arms of the first and second extensions of the grip handles are curved. In particular, the ends of one of the gripping arm portions are curved towards the ends of the other of the gripping arm portions.

Pursuant to another specific embodiment of the present invention, the first and second extensions and their first and second gripping arm portions can be respective single components. Alternatively, the extensions and the gripping arm portions can also be separate components that are interconnected to one another.

Further specific features of the present application will be described in detail subsequently.

### DESCRIPTION OF SPECIFIC EMBODIMENTS

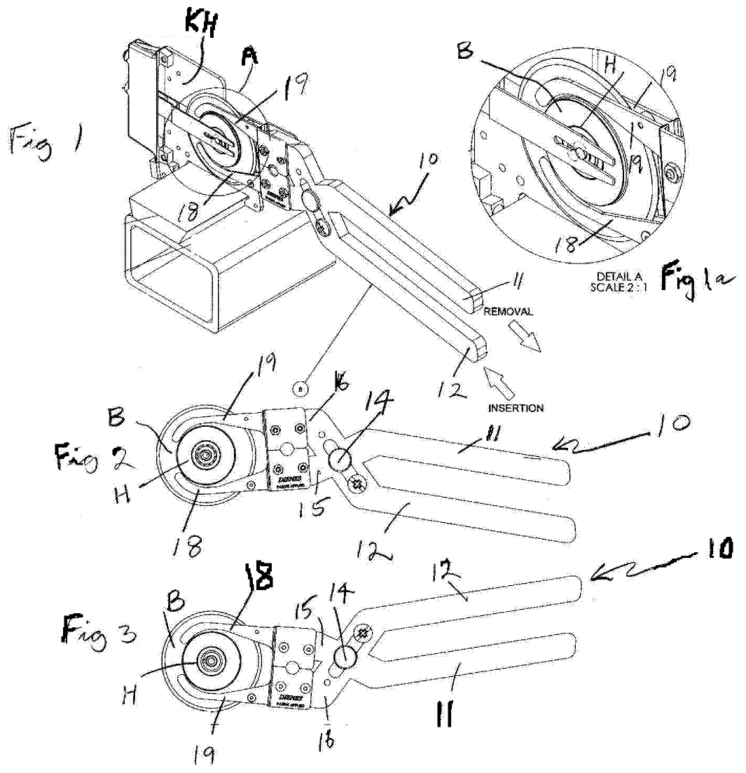

Referring now to the drawings in detail, the drawings show one exemplary embodiment of applicant's manual device 10 for installing and removing essentially circular knife blades from knife holders of slitting machines (see FIG. 1). In particular, FIGS. 1a, 2 and 3 show details of the manual device 10, the components and operation of which will be described below.

The manual device 10 is comprised of a first grip handle 11 and a second grip handle 12. These grip handles 11, 12 are pivotably interconnected by means of a pivot pin 14, so that gripping means associated with the grip handles 11, 12 can be moved toward and away from one another, as will be described subsequently. To accomplish the gripping function of the manual device 10, the first and second grip handles 11,12 have extensions with gripping arm portions. In particular, the first grip handle 11 has a first extension 15 extending away from the first grip handle 11 on a side of the pivot pin 14 that is remote from the first grip handle 11, and the second grip handle 12 has a second extension 16 that similarly extends away from the second grip handle 12 on a side of the pivot pin 14 that is remote from the second grip handle 12. The first extension 15, at an end thereof remote from the pivot pin 14, has two first gripping arm portions 18, which are spaced from one another. Similarly, the second extension 16 also has two second gripping arm portions 19, which are also spaced from one another (see in particular FIG. 1a). In the illustrated embodiment, the ends of respectively facing first and second gripping arm portions 18,19 are curved towards one another.

Since the first and second extensions 15, 16 extend away from the first and second grip handles 11, 12 on a side of the pivot pin 14 that is remote from the first and second grip handles 11, 12, the first and second extensions 15, 16 are also pivotable relative to one another, so that they, and hence their first and second gripping arm portions or simply gripping arms 18,19, can either be separated from one another or drawn toward one another by movement of the first and second grip handles 11, 12 away from or toward one another. In particular, for installing or removing a knife blade B into or from the knife holder K H, when the gripping arms 18,19 are separated from one another and are placed about the hubs H of a knife blade B, a movement of the first and second grip handles 11,12 toward one another results in movement of the gripping arms 18,19 of the first and second extensions 15,16 of the first and second grip handles 11,12 toward one another and allows engagement of the curved gripping arms 18,19 onto and about the hubs H of the blade B. In so doing, one of the two gripping arms 18 and one of the two gripping arms 19 are disposed on the hub on one side of the knife blade, while the other ones of the first and second gripping arms 18,19 are disposed on the hub on the opposite side of the knife blade. This provides four points of engagement, two on each side of the knife blade. By continuing to grip the first and second grip handles 11,12 together, the manual device 10 firmly holds or clamps the knife blade via its hubs, so that the knife blade can easily be removed from, or inserted into, the knife holder (see FIG. 1). The blade is securely held by having its hubs surrounded in a clamping manner. Not only does applicant's novel manual device 10 prevent damage to the knife blade, but risk of injury to an operator is also greatly reduced.

The first and second extensions 15,16 and their first and second gripping arm portions 18,19, can be respective single components. Alternatively, as illustrated, the extensions 15,16 and their first and second gripping arm portions 18,19 can be separate components that are interconnected by means of a connecting member 20.

The present invention is, of course, in no way restricted to the specific disclosure of the specification and drawings, but also encompasses any modifications within the scope of the appended claims.

What we claim is:

1. A manual device for installing and removing essentially circular knife blades into and from knife holders of slitting machines, comprising:
a first grip handle and a second grip handle that are pivotably interconnected by means of a pivot pin;
a first extension of said first grip handle, wherein said first extension extends away from said first grip handle on a side of said pivot pin that is opposite from said first grip handle, wherein said first extension is provided with two first gripping arm portions that are disposed on an end of said first extension that is remote from said pivot pin, and wherein said two first gripping arm portions are spaced from one another;
a second extension of said second grip handle, wherein said second extension extends away from said second grip handle on a side of said pivot pin that is remote from said second grip handle, wherein said second extension is provided with two second gripping arm portions that are disposed on an end of said second extension that is remote from said pivot pin, wherein said two second gripping arm portions are spaced from one another, further wherein said first and second extensions are pivotably disposed relative to one another by means of said pivot pin such that said extensions are adapted to be separated from one another and drawn toward one another by movement of said first and second grip handles away from and toward one another respectively, and wherein movement of said grip handles toward one another results in movement of said two first extension gripping arm portions and of said two second extension gripping arm portions towards one another onto hubs of a knife blade such that one of said first gripping arm portions and one of said second gripping arm portions are disposed on one planar side of the knife blade while the other of said first and second gripping arm portions are disposed on an axially remote planar side of the knife blade, and the first gripping arm portions and the second gripping arm portions on each respective planar side of the knife blade are disposed on opposite axial sides of the hubs of the knife blade.

2. A device according to claim 1, wherein when said first and said second gripping arm portions are disposed on opposite axial sides of the hubs of the knife blade, four points of engagement of said gripping arm portions on said knife blade hubs are provided.

3. A device according to claim 1, wherein free ends of said first and second gripping arms, remote from said first and second extensions of said first and second grip handles, are curved.

4. A device according to claim 3, wherein said free ends of said gripping arm portions are curved toward one another.

5. A device according to claim 3, wherein said first and second extensions, and said first and second gripping arm portions thereof, are respective single components.

6. A device according to claim 3, wherein said first and second extensions, and said first and second gripping arm portions thereof, are separate components.

7. A device according to claim 6, which further includes connecting members for interconnecting separate first and second extensions and first and second gripping arm portions thereof.
